(19) United States
(12) Patent Application Publication
(10) Pub. No.: US 2023/0362213 A1
(43) Pub. Date: Nov. 9, 2023

(54) EXISTENCE MANAGEMENT, INCLUDING METAVERSE EXISTENCE MANAGEMENT

(71) Applicant: AT&T Intellectual Property I, L.P., Atlanta, GA (US)

(72) Inventors: Nigel Bradley, Canton, GA (US); Eric Zavesky, Austin, TX (US); James Pratt, Round Rock, TX (US); Ari Craine, Marietta, GA (US); Robert Koch, Peachtree Corners, GA (US)

(21) Appl. No.: 17/662,152

(22) Filed: May 5, 2022

(51) Int. Cl. H04L 65/1093

(52) U.S. Cl. CPC H04L 65/1093

(57) ABSTRACT

The disclosed technology is directed towards tracking the existence of a user in one or more virtual worlds, that is, in the metaverse, and managing the existence(s) across the worlds, which also may include real world existence. When a user enters a virtual world, a user registers his or her existence in that world. Via preference settings the user can elect to share his or her existence in each virtual world when existing therein, as well as choose to disclose the user's virtual location within the virtual world. Other users can then see the existence and request to join, including at the location if disclosed. A user can use the technology to decide whether to meet up with other users in their respective worlds, including communicating to request joining another user, e.g., at that user's location. Future scheduled existence in a world also can be previewed.

### TECHNICAL FIELD

The subject application relates to devices and virtual worlds in general, and more particularly to tracking and managing the existence of users in virtual worlds, and related embodiments.

### BACKGROUND

Contemporary users of virtual reality devices can interact with each other, leave one virtual world and join another, or exit virtual reality altogether. This can cause confusion and lead to inefficiencies. For example, when thinking of joining a virtual world experience, trying to remember whether a friend is active in that virtual world can be confusing; having to determine each time which friends are currently in a given virtual world so that the user can decide whether to join can be inefficient.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram of an example system for tracking and managing the existence of a user across virtual worlds, and the user's interactions with other users across virtual worlds, in accordance with various aspects and embodiments of the subject disclosure.

FIG. 2 is a representation of an example user interface by which a user can interact to manage existence of the user across virtual worlds, in accordance with various aspects and embodiments of the subject disclosure.

FIG. 3 is a representation of an example interactive user interface coupled to a data structure by which a user can manage existence of the user across virtual worlds, in accordance with various aspects and embodiments of the subject disclosure.

FIG. 4 is a representation of an example interactive user interface by which a user can view a scheduled existence of the user across virtual world(s), in accordance with various aspects and embodiments of the subject disclosure.

FIG. 5 is a representation of an example interactive user interface by which a user can manage privacy or sharing of the existence of the user across virtual worlds, in accordance with various aspects and embodiments of the subject disclosure.

FIG. 6 is a representation of an example interactive user interface by which one user can determine the existence of another user in a virtual world, in accordance with various aspects and embodiments of the subject disclosure.

FIG. 7 is a representation of an example interactive user interface by which one user can ask to join a user in a virtual world, in accordance with various aspects and embodiments of the subject disclosure.

FIG. 8 is a representation of an example virtual reality view of a first user in which a second user is asking to join the first user in a virtual world, in accordance with various aspects and embodiments of the subject disclosure.

FIG. 9 is a representation of an example virtual reality view of a first user in which a second user is asking the first user to ask a third user, on behalf of the first user, to join the third user in a virtual world, in accordance with various aspects and embodiments of the subject disclosure.

FIG. 10 is a flow diagram representing example operations related to communicating existence status of a first user in an environment to a device associated with a second user, in accordance with various aspects and embodiments of the subject disclosure.

FIG. 11 is a flow diagram representing example operations related to communicating existence status of a first user in a virtual world to a device associated with a second user, in accordance with various aspects and embodiments of the subject disclosure.

FIG. 12 is a flow diagram representing example operations related to tracking existence statuses of a user among respective virtual worlds associated with the user, in accordance with various aspects and embodiments of the subject disclosure.

FIG. 13 illustrates an example block diagram of an example mobile handset operable to engage in a system architecture that facilitates wireless communications according to one or more embodiments described herein.

FIG. 14 illustrates an example block diagram of an example computer/machine system operable to engage in a system architecture that facilitates wireless communications according to one or more embodiments described herein.

### DETAILED DESCRIPTION

The technology described herein is generally directed towards tracking and managing the existence of a user across their worlds, along with the tracking and managing interactions with other users across their worlds. The existence management includes enabling existence registration, existence sharing, and other functions across the real world and one or more virtual worlds. The existence and interaction tracking and management can be performed in a generally integrated manner as described herein, making interactions and communications more efficient.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

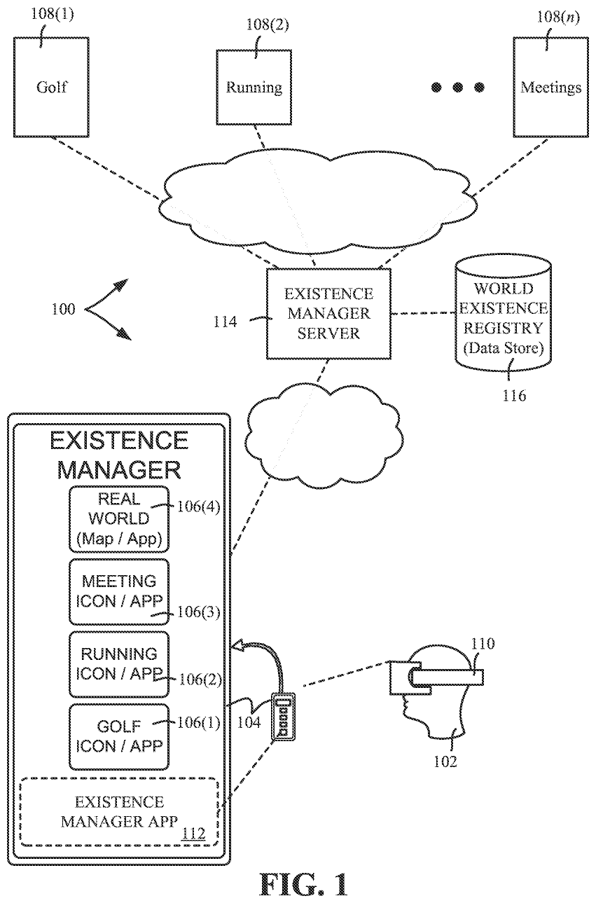

FIG. 1 shows a general system architecture 100 in which a user 102 is equipped with a communication device 104 (shown both as a smaller device as well as in an enlarged depiction). The device 104 may run one or more application programs (apps, four examples are shown with representative icons labeled 106(1)-106(4). Some or all of these apps 106(1)-106(4) may be in communication with one or more corresponding servers, such as including the example servers 108(1)-108(n) in FIG. 1. As is understood, these are non-limiting apps and servers, and a user may have fewer such apps and corresponding servers, not all of those depicted, or more than those depicted.

In one implementation, the communication device 104 has virtual reality capabilities or is coupled to a headset device 110 or the like that has virtual reality capabilities. Thus, the interfaces and other rendered output shown herein can be on a device such as a smartphone coupled to the headset device 110 or the like with virtual reality capabilities. Alternatively, the interfaces and other rendered output shown herein can be shown as part of a virtual reality experience, that is, via the headset device 110 or the like with virtual reality capabilities. Still further, the interfaces and other rendered output shown herein can be shown as part of a two-dimensional interactive/viewing experience without necessarily needing a device with virtual reality capabilities; for example, a user can virtually join a real or virtual run via a two-dimensional display monitor coupled to a treadmill or other running simulation device. Notwithstanding these alternatives, for brevity hereinafter consider that the apps 106(1)-106(4) represent virtual reality applications that are in communication with corresponding virtual reality servers 108(1)-108(n).

As shown in FIG. 1, the communication device 104 also may be equipped with an existence manager app (application program) 112 that is used to manage the user's existence in one or more worlds. An existence manager server 114, coupled to a world existence registry 116 (a data store such as a database) may be in communication with the existence manager app 112. As will be understood, the existence manager app 112 and the existence manager server 114 can work together to perform or assist in performing many of the operations described herein.

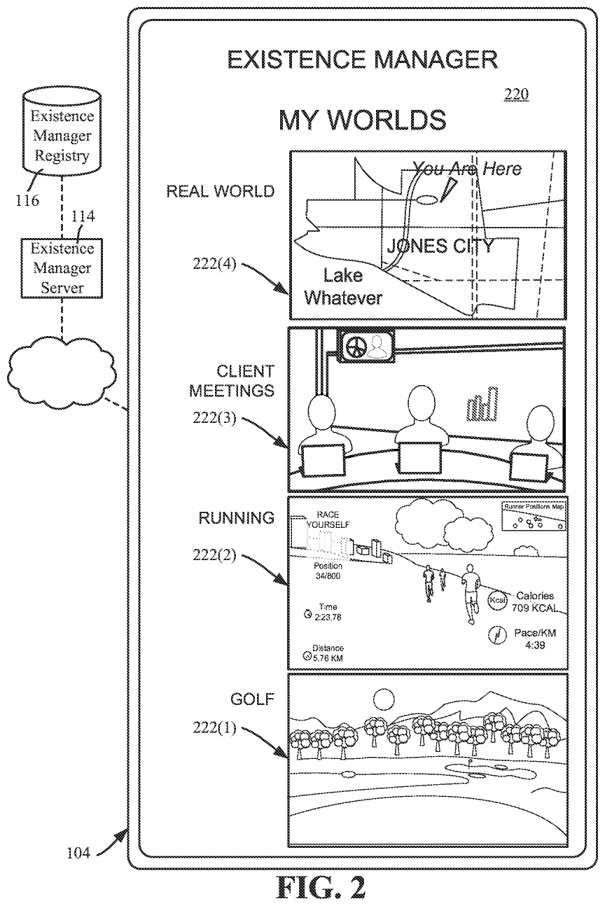

As shown in FIG. 1 and in FIG. 2 via the example interface 220 of the existence manager app 112, the worlds may include the real world (represented by the map app 106(4) of FIG. 1 and the displayed representation 222(4), and one or more virtual worlds that are created by the virtual reality apps 106(1)-106(3) and depicted in FIG. 2 via their displayed representations 222(1)-222(3), and their respective corresponding servers 108(1)-106(n). Note that it is feasible to exist in multiple virtual worlds at the same time, e.g., such as via different independent devices. It is also feasible to view representations of multiple virtual worlds at the same time, e.g., to select one with which to interact and/or join.

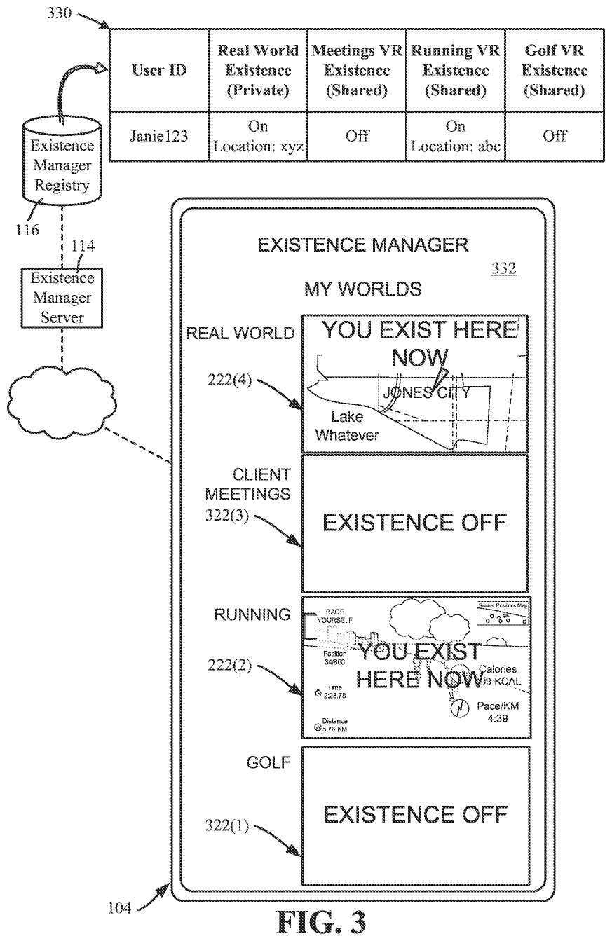

When the user uses a virtual reality app to connect to a virtual reality server, the existence manager app 112 (and/or the existence manager server 114) may be in communication with the virtual reality app 112 and/or the corresponding virtual reality server 114 to receive a notification of this connection. As generally represented in FIG. 3, upon notification of the connection, the existence management server 114 may be notified by the existence manager app 112 of the user's existence in the virtual reality app, (or vice versa if appropriate). This results in existence registration, in which the existence manager server 114 creates a registry entry 330 (e.g., a database record) for the user in the existence registry database 116. In this example, the registry entry 330 for the user includes a unique ID for the user as well as an indication of in which virtual reality worlds the user currently exists. Further, the virtual reality server (e.g., the server 108(2)) for the running app) or the app (e.g., the running app 106(2)) may indicate a virtual location for the user in each of their active virtual reality worlds. This virtual location may, for example, indicate virtual geographical coordinates or the like for the user in each of their virtual reality world(s) in which he or she is active. This virtual location may be continually or regularly updated by the virtual reality server (e.g., the server 108(2)) communicating with the existence manager app 112 and existence manager server 114. The existence manager 114 may present a user interface 332 to the user via the communication device 104 that presents a visual of which worlds the user exists in at the current time, as also shown in the example of FIG. 3. Note that this example includes the real world (represented via visual 222(4) as well as the running virtual world (represented via visual 222(2). The other virtual worlds representations are updated to 322(3) and 322(1) to indicate that the user is not presently in these virtual worlds, that is, the user's existence is off.

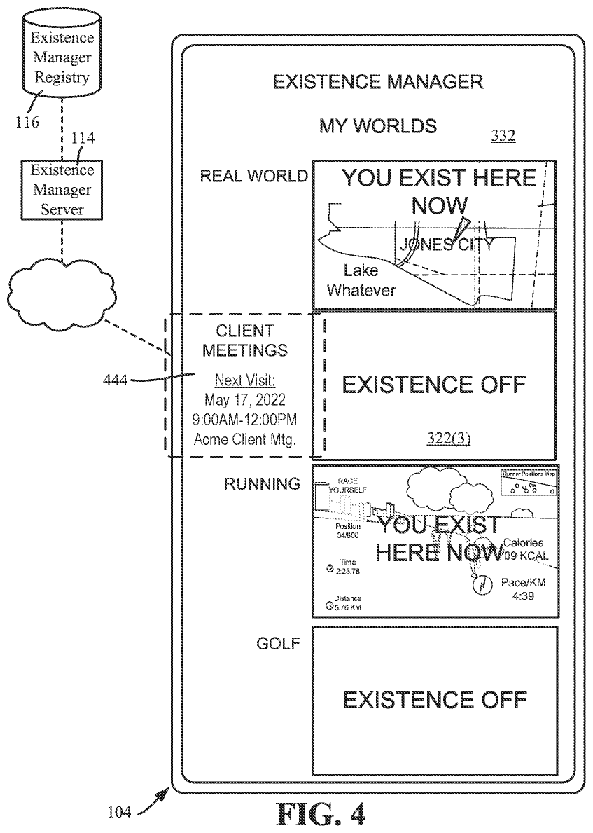

Turning to another aspect, namely existence scheduling, FIG. 4 shows an example in which the existence manager has obtained data for the user from one or more of the virtual reality apps (or some other calendar tied to a virtual reality app). In this example, the meetings app, and more particularly the “CLIENT MEETINGS” part thereof in which existence is off as indicated via graphic image visual 322(2), is shown as accompanied by displayed future scheduled existence data for each of those apps to display future visits that are scheduled to those one or more virtual worlds, to the extent such scheduling data exists. In this example, the “CLIENT MEETINGS” scheduling data is displayed within the area represented by the dashed block 444 of an existence manager interface 446. Note that although not explicitly shown in FIG. 4, the scheduling data can be interactive, such as to move forwards or backwards in time/date to see additional visit-related data.

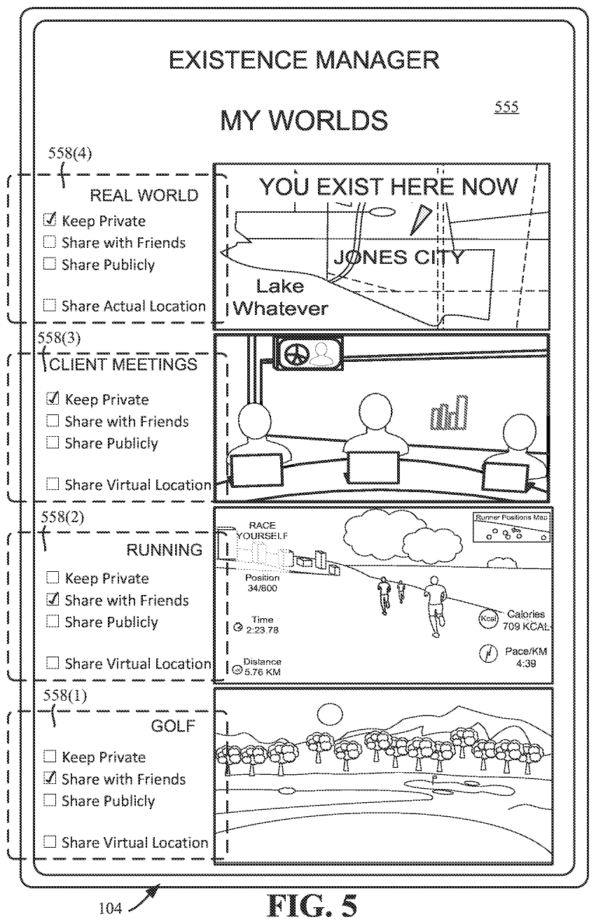

Existence sharing also can be managed by the user, as generally represented in the example interface 555 of FIG. 5. Consider that the user has defined a set of one or more friends with which the user is willing to share his or her existence status. Note that this set of friends may be defined and stored in the existence registry 116, for example, and/or locally in the device 104. That is, other users who store their existence in the registry or other shared storage may become a social group and specified as “existence friends” for the user.

With this set of friends, as shown via the interactive elements within the dashed blocks 558(1)-558(4) the user may specify for each of their worlds whether or not to share his or her existence status with their existence friends, the public, or to keep the existence private. The user may further specify this sharing at a more granular level for each of the worlds, by optionally defining whether to share not only the user's existence status in each world but also the user's (e.g., current) virtual (or real) location in each world. Note that although not explicitly shown in FIG. 5, there can be multiple, different sets of friends, e.g., set(s) of social friends for golf and/or running existence, a set of professional friends tied to meeting existence, and so on.

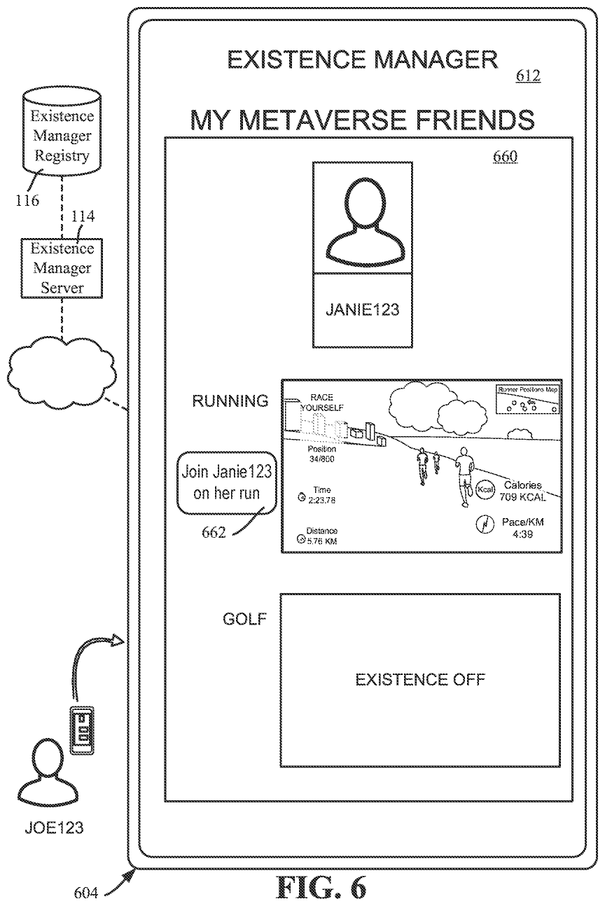

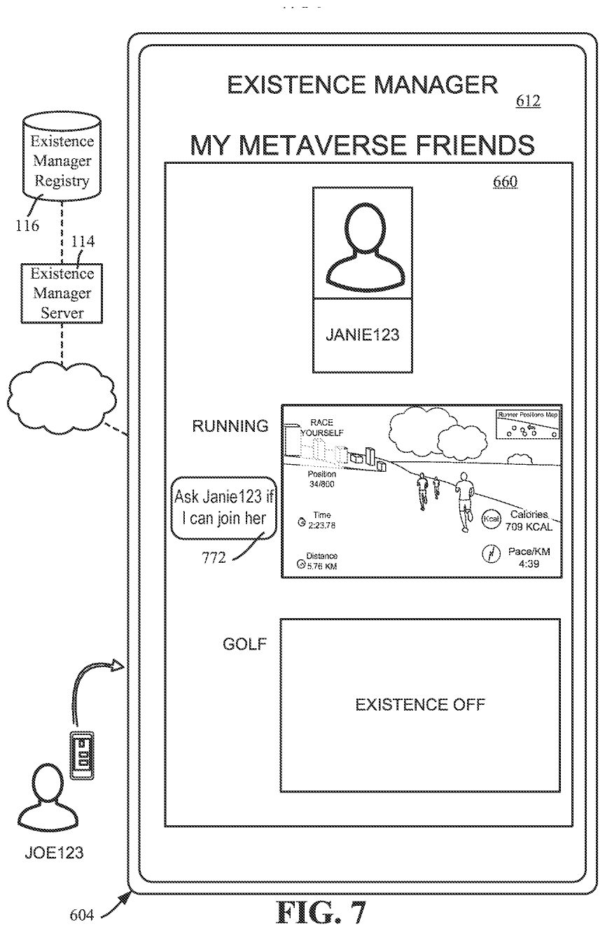

Such sharing can lead to meet-ups with friends, as generally represented in FIG. 7. In this example, by sharing her presence in in one or more of her virtual worlds, a user, JANIE123, may permit her existence friends to see in which virtual world(s) she exists, and also to meet her in the world in which she exists. This may be considered to be a metaverse meet-up enabler. In the example shown, JOE123 via his communication device 604 and user interface 660 may be able to view JANIE123's metaverse existence and, such as if invited (block 662, FIG. 6), request to join her (block 772, FIG. 7) wherever she exists in her metaverse. In particular, if JANIE123 shared her virtual location within the virtual world in which she exists, JOE123 may meet her at that virtual location in that virtual world. The effect in this case may be for JOE123 to join JANIE123 on her virtual run. This is accomplished by having an existence manager app 612 for JOE123 (or via the existence manager server 114) request a connection between his running app and the running server 108(2) (FIG. 1) and to specify the virtual location to be used when the connection is initiated.

This solution also enables users to communicate with each other across worlds, which can be referred to as cross-world communication. For example, JOE123 may exist in one of his virtual worlds, and view an instance of his existence manager app from within that world. JOE123 may use the controls and commands that are native to the world he is in to communicate with JANIE123, who exists in another virtual world. JOE123 may send a request communication to JANIE123 via his existence manager app.

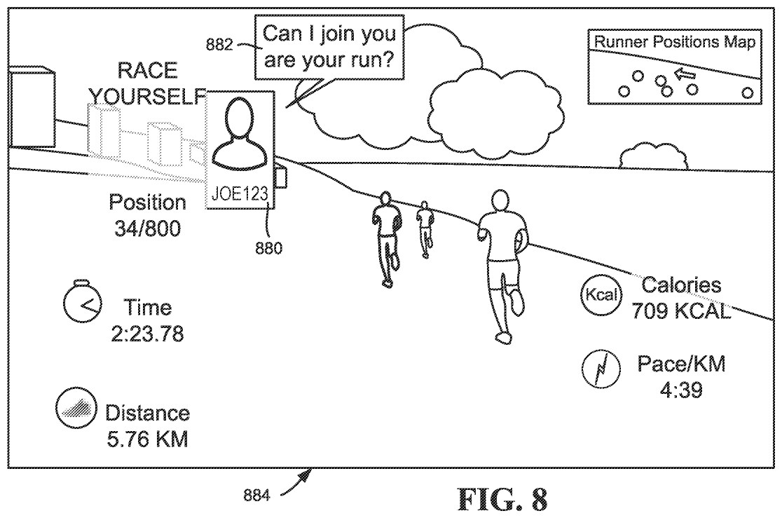

JOE123 may have previously stored data representing an avatar for himself in his existence registry record or other accessible location. As shown in the example of FIG. 8, upon receiving JOE123's request to communicate with JANIE123, the existence manager server 114 may access the avatar and the contents of the communication and send them to JANIE123's virtual reality app, whereby the avatar data 880 and communication data 882 may be presented within JANIE123's virtual reality world 884 in which she exists. JANIE123 may further respond to the communication request from JOE123. In this manner, the existence manager/existence manager server 114 acts as a communication mediator between the two virtual worlds.

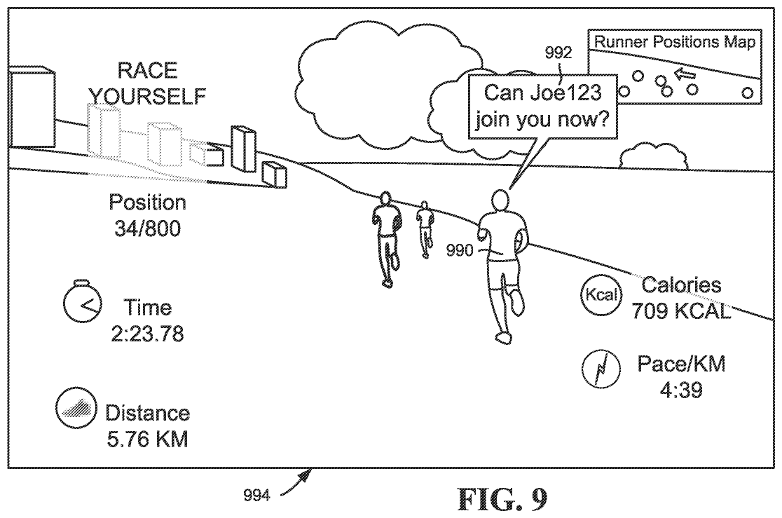

In another embodiment represented in the example of FIG. 9, JANIE123's virtual app may receive the communication request and not use JOE123's avatar, but rather use another element that is native to JANIE123's current world. The element may be another character in the virtual world (e.g., the avatar 990 in FIG. 9 displays the communication data 992), an available flat surface, such as the side of a building to “project” the communication request, or other such temporary visible region, not necessarily otherwise within the virtual reality world representation 994. The communication request may also be presented as audio from JOE123's avatar or other element.

It should be noted that one user may be in the real world, and another user can virtually join that user. Consider for example a user with a mobile camera who is actually running in the real world and providing a live feed of their run (or someone else is providing the live feed). The other user can virtually join the live feed as a virtual runner in this example. Thus, for example, the representation 994 of FIG. 9 can instead be an actual camera feed, possibly overlaid with other data when viewed by others. If private, a user may need to request to join virtually, or if public may not need to request to join as a virtual runner in this scenario.

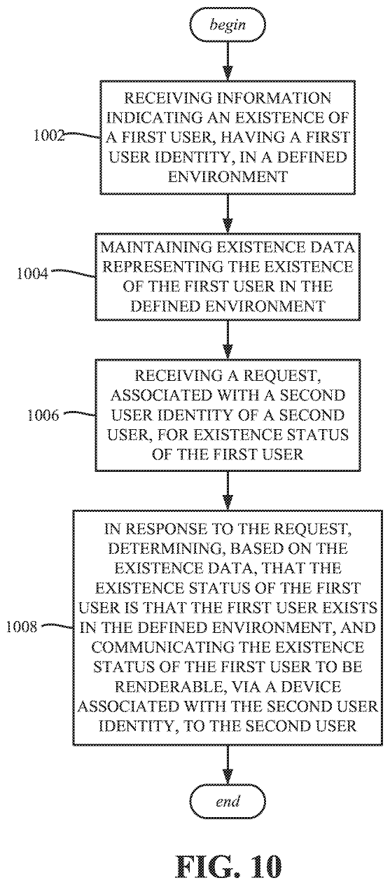

One or more example aspects are represented in FIG. 10, and can correspond to a system, including a processor, and a memory that stores executable instructions and/or components that, when executed by the processor, facilitate performance of operations. Example operation 1002 represents receiving information indicating an existence of a first user, having a first user identity, in a defined environment. Example operation 1004 represents maintaining existence data representing the existence of the first user in the defined environment. Example operation 1006 represents receiving a request, associated with a second user identity of a second user, for existence status of the first user. Example operation 1008 represents, in response to the request, determining, based on the existence data, that the existence status of the first user is that the first user exists in the defined environment, and communicating the existence status of the first user to be renderable, via a device associated with the second user identity, to the second user.

The defined environment can include a virtual world. The request can be a first request, and further operations can include receiving a second request, associated with the second user identity of the second user, to join the first user identity of the first user in the virtual world. The existence status can include data representing a virtual location of the first user as a virtualized first user associated with the first user identity in the virtual world. The request can be a first request, and further operations can include receiving a second request, associated with the second user identity of the second user, to join the first user as the virtualized first user in the virtual world at the virtual location, and, in response to the second request, joining the second user as a virtualized second user associated with second user identity to the virtualized first user in the virtual world at the virtual location.

The device associated with the second user identity can be a second device, and further operations can include notifying a first device associated with the first user identity of the existence of the first user in the defined environment.

The device associated with the second user identity can be a second device, the defined environment can include a virtual world, and further operations can include notifying a first device associated with the first user identity of the existence of the first user as a virtualized first user associated with the first user identity in the virtual world at a virtual location.

Further operations can include, prior to communicating the existence status of the first user to the device associated with the second user identity, verifying, based on the second user identity, that the second user is allowed to receive the existence status.

The existence status can include location data representing a location of the first user in the defined environment, and further operations can include, prior to communicating the existence status of the first user to the device associated with the second user, verifying, based on the second user identity and the location of the first user in the defined environment, that the second user is allowed to receive the existence status that comprises the location data.

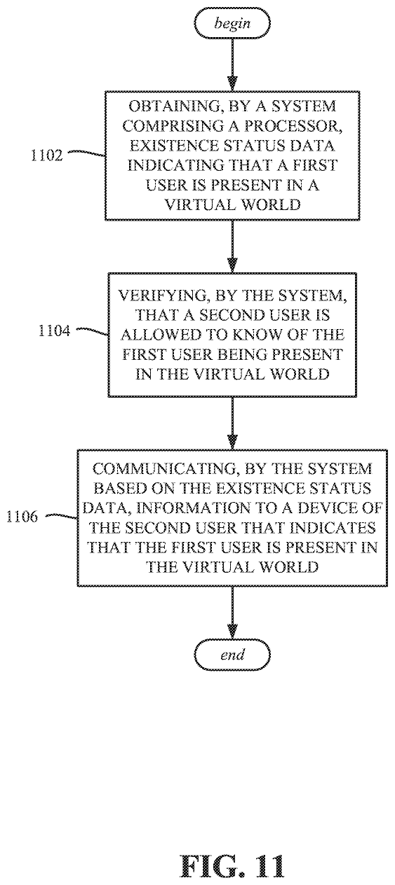

One or more example aspects are represented in FIG. 11, and, for example, can correspond to operations, such as of a method. Example operation 1102 represents obtaining, by a system comprising a processor, existence status data indicating that a first user is present in a virtual world. Example operation 1104 represents verifying, by the system, that a second user is allowed to know of the first user being present in the virtual world. Example operation 1106 represents communicating, by the system based on the existence status data, information to a device of the second user that indicates that the first user is present in the virtual world.

Communicating the existence status data can include sending location data that represents a virtual location of the first user in the virtual world.

The system can include a user device, and further operations can include outputting, via an interface of the user device, data representing that the first user is present in the virtual world.

The system can include a user device, and further operations can include outputting, via an interface of the user device, first data representing a physical location of the user in a real-world environment, and second data representing a virtual location of the user in the virtual world.

Further operations can include obtaining, by the system, invitation data representing an invitation from the first user to join the first user in the virtual world; verifying that the second user is allowed to know of the first user being present in the virtual world, and communicating the information to the device of the second user that indicates that the first user is present in the virtual world, can occur in response in response to obtaining the invitation data.

Further operations can include obtaining, by the system, a request from the second user requesting to join the first user in the virtual world; verifying that the second user is allowed to know of the first user being present in the virtual world, and communicating the information to the device of the second user that indicates that the first user is present in the virtual world, can occur in response in response to obtaining the request.

The device of the second user can be a second device, and further operations can include joining, by the system, the second user to the virtual world, and based on the joining, presenting, by the system, a visual representation of the second user in the virtual world via a first device of the first user.

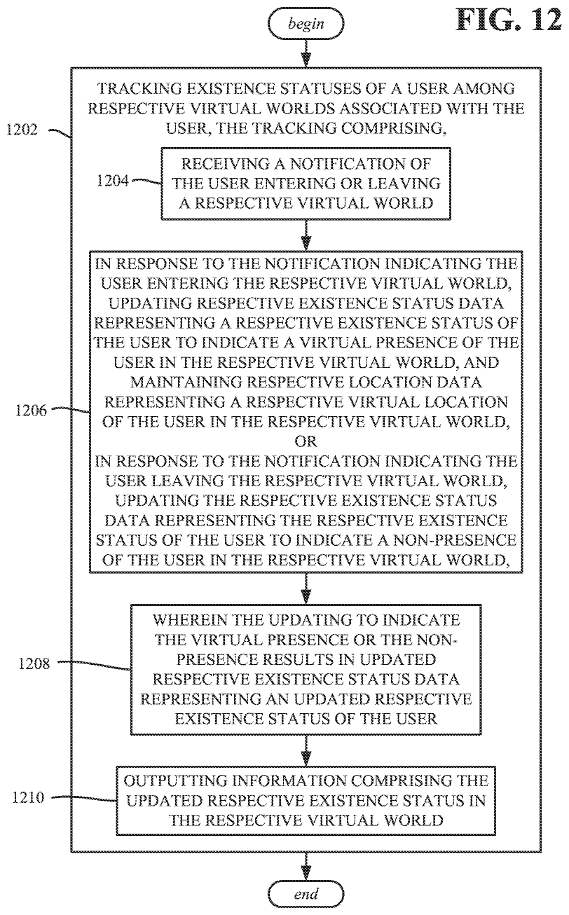

One or more aspects are represented in FIG. 12 such as implemented in a machine-readable medium, including executable instructions that, when executed by a processor of a device, facilitate performance of operations. Example operation 1202 represents tracking existence statuses of a user among respective virtual worlds associated with the user. The tracking can include receiving a notification of the user entering or leaving a respective virtual world (operation 1204), in response to the notification indicating the user entering the respective virtual world, updating respective existence status data representing a respective existence status of the user to indicate a virtual presence of the user in the respective virtual world, and maintaining respective location data representing a respective virtual location of the user in the respective virtual world, or in response to the notification indicating the user leaving the respective virtual world, updating the respective existence status data representing the respective existence status of the user to indicate a non-presence of the user in the respective virtual world (operation 1206), wherein the updating to indicate the virtual presence or the non-presence results in updated respective existence status data representing an updated respective existence status of the user (operation 1208) and outputting information comprising the updated respective existence status in the respective virtual world (operation 1210).

The user can be a first user, and outputting the information representing the updated respective existence status in the respective virtual world can include sending a communication to a device of a second user.

The user can be a first user, and further operations can include accessing a data store comprising user identities, verifying, based on accessing the data store, that a second user is allowed to be notified of the updated respective existence status, and based on the verifying, sending a communication that represents the updated respective existence status to a device of the second user.

The user can be a first user, the updated respective existence status data can be indicate that the first user is virtually present in the respective virtual world, and further operations can include sending a communication that represents the updated respective existence status and the respective location data to a device of a second user, and joining the second user to the respective virtual world at a virtual location based on the respective location data.

As can be seen, the technology described herein facilitates more efficient management of existence and/or interactions of a user with virtual reality capabilities with other users, including across virtual worlds. The management and tracking technology described herein can reduce user confusion, while making interactions and communication with others more efficient.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

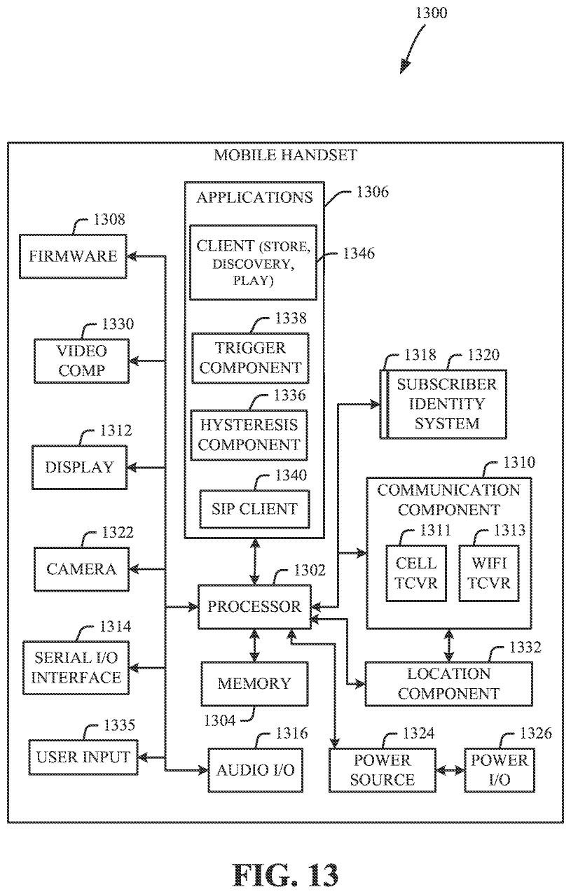

Referring now to FIG. 13, illustrated is a schematic block diagram of an example end-user device (such as user equipment) that can be a mobile device 1300 capable of connecting to a network in accordance with some embodiments described herein. Although a mobile handset 1300 is illustrated herein, it will be understood that other devices can be a mobile device, and that the mobile handset 1300 is merely illustrated to provide context for the embodiments of the various embodiments described herein. The following discussion is intended to provide a brief, general description of an example of a suitable environment 1300 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1300 includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE-1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 810, includes an indoor network radio transceiver 1313 (e.g., Wi-Fi transceiver). This function supports the indoor radio link, such as IEEE 802.11, for the dual-mode GSM handset 1300. The handset 1300 can accommodate at least satellite radio services through a handset that can combine wireless voice and digital radio chipsets into a single handheld device.

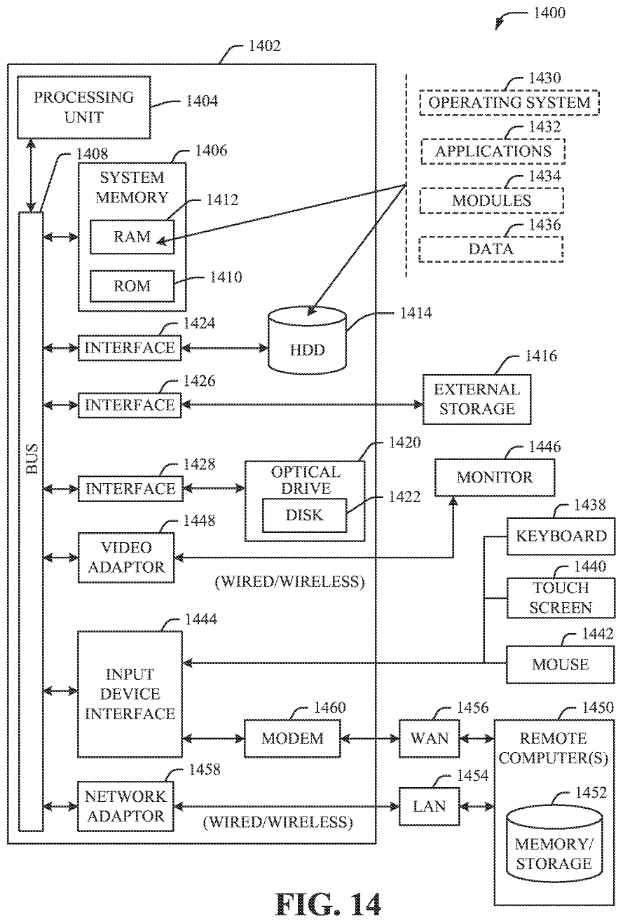

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD), non-volatile memory and other storage technology could be used in addition to, or in place of, an HDD 1414, and can be internal or external. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE-1394) interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE-1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 14 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

1. A system, comprising:
a processor; and
a memory that stores executable instructions that, when executed by the processor of the system, facilitate performance of operations, the operations comprising:
receiving existence information representative of existence of a first user, having a first user identity, in a defined environment of a group of defined environments registered with the first user identity;
based on the existence information, maintaining existence data representative of existence of the first user in the group of defined environments;
receiving a request, associated with a second user identity of a second user, for an existence status of the first user; and
in response to receiving the request,
determining, based on the existence data, the existence status of the first user, wherein determining the existence status of the first user comprises determining that the first user exists in the defined environment, and
communicating existence status data representative of the existence status of the first user to a device associated with the second user identity.

2. The system of claim 1, wherein the group of defined environments comprises respective virtual worlds, and wherein the defined environment comprises a virtual world of the respective virtual worlds.

3. The system of claim 2, wherein the request is a first request, and wherein the operations further comprise:
receiving a second request, associated with the second user identity of the second user, to join the first user identity of the first user in the virtual world.

4. The system of claim 2, wherein the existence status comprises data representative of respective virtual locations of the first user as a virtualized first user, associated with the first user identity, in the respective virtual worlds.

5. The system of claim 4, wherein the request is a first request, and wherein the operations further comprise:
receiving a second request, associated with the second user identity of the second user, to join the virtualized first user in the virtual world at a virtual location of the respective virtual locations, and
in response to receiving the second request, joining the second user as a virtualized second user, associated with second user identity, to the virtualized first user in the virtual world at the virtual location.

6. The system of claim 1, wherein the device associated with the second user identity is a second device, and wherein the operations further comprise:
notifying a first device associated with the first user identity of the existence of the first user in the defined environment.

7. The system of claim 1, wherein the device associated with the second user identity is a second device, wherein the defined environment comprises a virtual world, and wherein the operations further comprise:
notifying a first device associated with the first user identity of the existence of the first user, as a virtualized first user, associated with the first user identity at a virtual location in the virtual world.

8. The system of claim 1, wherein the operations further comprise:
prior to communicating the existence status of the first user to the device associated with the second user identity, verifying, based on the second user identity, that the second user is permitted to receive the existence status, wherein the existence status data is communicated to the device in response to the second user being determined to be permitted to receive the existence status data.

9. The system of claim 1, wherein the existence status data comprises location data representative of a location of the first user in the defined environment, and wherein the operations further comprise:
prior to communicating the existence status data of the first user to the device associated with the second user, verifying, based on the second user identity and the location of the first user in the defined environment, that the second user is permitted to receive the existence status data, comprising the location data, wherein the existence status is communicated to the device in response to the second user being determined to be permitted to receive the existence status data.

10. A method, comprising:
obtaining, by a system comprising a processor, existence status data representative of presence of a first user in a virtual world of a group of virtual worlds registered with the first user;
verifying, by the system, that a second user is permitted to access the existence status data; and
transmitting, by the system to a device registered with the second user, the existence status data, wherein the existence status data comprises an indication that the first user is present in the virtual world.

11. The method of claim 10, wherein transmitting the existence status data comprises sending location data representative of a virtual location of the first user in the virtual world.

12. The method of claim 10, wherein the system comprises a user device, and wherein the method further comprises:
outputting, by the system via an interface of the user device, data representative of a presence of the first user in the virtual world.

13. The method of claim 10, wherein the system comprises a user device, and wherein the method further comprises:
outputting, by the system via an interface of the user device, first data representative of a physical location of the first user in a real-world environment and second data representative of a virtual location of the first user in the virtual world.

14. The method of claim 10, further comprising:
obtaining, by the system, invitation data representative of an invitation from the first user to join the first user in the virtual world,
wherein verifying that the second user is permitted to access the existence status data, and transmitting the existence status data to the device of the second user that indicates occur in response to the invitation data being obtained from the first user.

15. The method of claim 10, further comprising:
receiving, by the system, a request from the second user requesting to join the first user in the virtual world,
wherein verifying that the second user is permitted to access the existence status data and transmitting the existence status data to the device of the second user occur in response in response to the request being received from the second user.

16. The method of claim 10, wherein the device registered with the second user comprises a second device, and wherein the method further comprises:
joining, by the system, the second user to the virtual world, and
based on joining the second user to the virtual world, rendering, by the system, a visual representation of the second user in the virtual world via a first device registered with the first user.

17. A non-transitory machine-readable medium, comprising executable instructions that, when executed by a processor, facilitate performance of operations, the operations comprising:
receiving a notification of a user identity being associated with entering or leaving a respective virtual world of a group of virtual worlds registered with the user identity;
in response to the notification being determined to indicate the user identity being associated with entering the respective virtual world,
updating respective existence status data representative of a respective existence status of the user identity in the group of virtual worlds to indicate a virtual presence of the user identity in the respective virtual world, resulting in updated respective existence status data applicable to the user identity, and
maintaining respective location data representative of a respective virtual location of the user identity in the respective virtual world; or
in response to the notification being determined to indicate the user identity being associated with leaving the respective virtual world,
updating the respective existence status data representative of the respective existence status of the user identity to indicate a non-presence of the user identity in the respective virtual world, resulting in the updated respective existence status data; and
generating an output representative of the updated respective existence status data.

18. The non-transitory machine-readable medium of claim 17, wherein
the user identity comprises a first user identity, and wherein the operations further comprise:
sending the output to a device registered with a second user identity.

19. The non-transitory machine-readable medium of claim 17, wherein the user identity comprises a first user identity, and wherein the operations further comprise:
accessing a data store comprising a group of user identities and respective user identity permissions, wherein the group of user identities comprises the first user identity;
in response to accessing the data store, verifying that a second user identity is permitted to be notified of the updated respective existence status data; and
in response to verifying that the second user identity is permitted to be notified of the updated respective existence status, sending, to a device registered with the second user identity, a communication representative of the updated respective existence status data.

20. The non-transitory machine-readable medium of claim 17, wherein
the user identity comprises a first user identity, wherein the updated respective existence status data indicates that the first user identity is virtually present in the respective virtual world, and wherein the operations further comprise:
sending, to a device registered with a second user identity, a communication representative of the updated respective existence status data and the respective location data; and
based on the respective location data, joining the second user identity to the respective virtual world at a virtual location applicable to the respective location data.
